(19) United States
(12) Patent Application Publication
(10) Pub. No.: US 2007/0026221 A1
(43) Pub. Date: Feb. 1, 2007

(54) Morphological forms of fillers for electrical insulation

(75) Inventors: Gary Stevens, Surrey (GB); James D. B. Smith, Monroeville, PA (US); John W. Wood, Winter Springs, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/529,181

(22) Filed: Sep. 28, 2006

Related U.S. Application Data
(63) Continuation-in-part of application No. 11/152,983, filed on Jun. 14, 2005.

(51) Int. Cl. B32B 5/14; B32B 18/00; G11B 11/105

(52) U.S. Cl. 428/325; 428/308.8; 428/332; 428/366

(57) ABSTRACT

A high thermal conductivity resin that has a host resin matrix, and a high thermal conductivity filler. The high thermal conductivity filler (30) forms a continuous organic-inorganic composite with the host resin matrix. The fillers are from 1-1000 nm in length, and have average aspect ratios of between 3-100. At least a portion of the high thermal conductivity fillers comprise morphologies (31) chosen from one or more of hexagonal, cubic, orthorhombic, rhombohedral, tetragonal, whiskers and tubes. In particular, some of the fillers will aggregate into secondary structures.

### CROSS-REFERENCE TO RELATED APPLICATIONS

This application is a continuation-in-part of U.S. application Ser. No. 11/152,983, “High Thermal Conductivity Materials Incorporated into Resins” filed Jun. 14, 2005, by Smith, et al., which is incorporated herein by reference.

### FIELD OF THE INVENTION

The field of the invention relates to resins with aligned high thermal conductivity materials incorporated therein, including materials with particular morphologies.

### BACKGROUND

With the use of any form of electrical appliance, there is a need to electrically insulate conductors. With the push to continuously reduce the size and to streamline all electrical and electronic systems there is a corresponding need to find better and more compact insulators and insulation systems.

Various epoxy resin materials have been used extensively in electrical insulation systems due to their practical benefit of being tough and flexible electrical insulation materials that can easily adhere to surfaces. Traditional electrical insulation materials, such as mica flake and glass fiber, can be surface coated and bonded with these epoxy resins, to produce composite materials with increased mechanical strength, chemical resistance and electrical insulating properties. In many cases, epoxy resins have replaced traditional varnishes despite such materials having continued use in some high voltage electrical equipment.

Good electrical insulators, by their very nature, also tend to be good thermal insulators, which is undesirable. Thermal insulating behavior, particularly for air-cooled electrical equipment and components, reduces the efficiency and durability of the components as well as the equipment as a whole. It is desirable to produce electrical insulation systems having maximum electrical insulation and minimal thermal insulation characteristics.

Electrical insulation often appears in the form of insulating tapes, which themselves have various layers. Common to these types of tapes is a paper layer that is bonded at an interface to a fiber layer, both layers tending to be impregnated with a resin. A favored type of insulation material is a mica-tape. Improvements to mica tapes include catalyzed mica tapes as taught in U.S. Pat. No. 6,103,882. The mica-tape may be wound around conductors to provide extremely good electrical insulation. An example of this is shown in FIG. 1. Illustrated here is a coil 13, comprising a plurality of turns of conductors 14, which in the example illustrated here are assembled into a bakelized coil. The turn insulation 15 is prepared from a fibrous material, for example glass or glass and Dacron which is heat treated. Ground insulation for the coil is provided by wrapping one or more layers of composite mica tape 16 about the bakelized coil 14. Such composite tape may be a paper or felt of small mica flakes combined with a pliable backing sheet 18 of, for example, glass fiber cloth or polyethylene glycol terephthalate mat, the layer of mica 20 being bonded thereto by a liquid resinous binder. Generally, a plurality of layers of the composite tape 16 are wrapped about the coil depending upon voltage requirements. A wrapping of an outer tape 21 of a tough fibrous material, for example, glass fiber, may be applied to the coil.

Generally, multiple layers of the mica tape 16 are wrapped about the coil with sixteen or more layers generally being used for high voltage coils. Resins are then impregnated into the tape layers. Resins can even be used as insulation independently from the insulating tape. Unfortunately, this amount of insulation only further adds to the complications of dissipating heat.

As mentioned, a primary insulator is mica in the form of flakes or platelets, which are then used in splittings or paper. Mica has good mechanical strength during winding and subsequent processing of the insulation, but one major problem associated with using mica is the poor wetting and adhesion of the mica surface to the impregnating resin, such as epoxy. This then creates microvoids during resin cure and interfacial delamination during service in high voltage electrical equipment. The micro pores within the mica are particularly poor for wetting and adhesion of the resin since they are deep within the mica paper.

Because of the poor wetting characteristics, it is difficult to get the impregnating resin, and fillers within the resin, to penetrate and adhere to these micropore areas of the mica. This poor adhesion of impregnating resin and fillers may cause air gaps in the structure which reduce thermal conductivity and migration and loss of the filler, consequently lowering thermal conduction properties in the mica insulation. Also, this low adhesion results in microvoid formation which in turn causes partial discharges under high voltage within the insulation structure resulting in inferior voltage endurance and thereby reducing the service lifetime of the electrical equipment.

What is needed are better types of filler compositions. Other difficulties with the prior art also exist, some of which will be apparent upon further reading.

### SUMMARY OF THE INVENTION

With the foregoing in mind, methods and apparatuses consistent with the present invention, which inter alia facilitates the transport of phonons through a high thermal conductivity (HTC) impregnated medium to reduce the mean distances between the HTC materials below that of the phonon mean free path length. This reduces the phonon scattering and produces a greater net flow or flux of phonons away from the heat source. The resins may then be impregnated into a host matrix medium, such as a multi-layered insulating tape.

High Thermal Conductivity (HTC) organic-inorganic hybrid materials may be formed from discrete two-phase organic-inorganic composites, from organic-inorganic continuous phase materials based on molecular alloys and from discrete organic-dendrimer composites in which the organic-inorganic interface is non-discrete within the dendrimer core-shell structure. Continuous phase material structures may be formed which enhance phonon transport and reduce phonon scattering by ensuring the length scales of the structural elements are shorter than or commensurate with the phonon distribution responsible for thermal transport, and/or that the number of phonon scattering centers are reduced such as by enhancing the overall structural order of the matrix, and/or by the effective elimination or reduction of interface phonon scattering within the composite. Continuous organic-inorganic hybrids may be formed by incorporating inorganic, organic or organic-inorganic hybrid nano-particles in linear or cross-linked polymers (including thermoplastics) and thermosetting resins in which nano-particles dimensions are of the order of or less than the polymer or network segmental length (typically 1 to 50 nm or greater).

These various types of nano-particles will contain reactive surfaces to form intimate covalently bonded hybrid organic-inorganic homogeneous materials. Similar requirements exist for inorganic-organic dendrimers which may be reacted together or with matrix polymers or reactive resins to form a continuous material. In the case of both discrete and non-discrete organic-inorganic hybrids it is possible to use sol-gel chemistry to form a continuous molecular alloy. The resulting materials will exhibit higher thermal conductivity than conventional electrically insulating materials and may be used as bonding resins in conventional mica-glass tape constructions, when utilized as unreacted vacuum-pressure impregnation resins and as stand alone materials to fulfill electrical insulation applications in rotating and static electrical power plants and in both high (approximately over 5 kV) and low voltage (approximately under 5 kV) electrical equipment, components and products.

In addition, the HTC fillers can take a variety of morphological shapes, both in their primary structure, and how they aggregate into secondary structures. The primary structures can be one or more of hexagonal, cubic, orthorhombic, rhombohedral, tetragonal, whiskers and tubes. These manifest themselves as high aspect ratio rods, spheroidals, platelets, discoids and cuboids, which shapes can be used individually or combined. Although these shapes have independent benefits, additional benefits may be obtained when secondary structures are formed. The secondary aggregate shapes formed can be one or more stacks, spheroids, splayed spheres, sheets, dendritic starts and pearl necklaces. In addition, when size distributions are mixed, secondary structures can be formed when larger primary morphologies are decorated by smaller materials.

The formation of engineered electrical insulation materials having prescribed physical properties and performance characteristics, and based on the use of nano-to-micro sized inorganic fillers in the presence of organic host materials, requires the production of particle surfaces which can form an intimate interface with the organic host. This may be achieved through the grafting of chemical groups onto the surface of the fillers to make the surface chemically and physically compatible with the host matrix, or the surfaces may contain chemically reactive functional groups that react with the organic host to form covalent bonds between the particle and the host. The use of nano-to-micro sized inorganic fillers in the presence of organic host materials requires the production of particles with defined surface chemistry in addition to bulk dielectric and electrical properties and thermal conductivity. Most inorganic materials do not allow independent selection of structural characteristics such as shape and size and properties to suit different electrical insulation applications or to achieve composites having the right balance of properties and performance. This may be achieved by selecting particles with appropriate bulk properties and shape and size characteristics and then modifying the surface and interfacial properties and other characteristics to achieve the additional control of composite properties and performance required for electrical insulation applications. This may be achieved by appropriate surface coating of the particles which may include the production of metallic and non-metallic inorganic oxides, nitrides, carbides and mixed systems and organic coatings including reactive surface groups capable of reacting with appropriate organic matrices which act as the host material in the electrical insulation system. The resulting hybrid materials when combined with organic resins as composites in unreacted or partially reacted form may be used as resins in mica-glass tape constructions, as unreacted vacuum-pressure impregnation resins for conventional mica tape constructions, in other glass fiber, carbon fiber and ply-type and textile composites and as stand alone materials to fulfill electrical insulation applications in rotating and static electrical power plant and in both high and low voltage electrical equipment, components and products. Organic-inorganic hybrid resins usable with the present invention include polyhedral oligomeric silsesquioxanes (POSS), tetraethyl orthosilicate (TEOS) and tetrabutyl orthotitanate (TBOT) and related monomeric and oligomeric hybrid compounds which are organic functionalized inorganic compounds

These and other objects, features, and advantages in accordance with the present invention are provided particular embodiments by a high thermal conductivity resin that comprises a host resin matrix, and a high thermal conductivity filler. The high thermal conductivity filler forms a continuous organic-inorganic composite with the host resin matrix, and is from 1-1000 nm in length, has an average aspect ratio of between 3-100, and more particularly 10-50, although aspect ratios of specific particles can be outside of this average. A portion of the high thermal conductivity fillers comprise morphologies chosen from one or more of hexagonal, cubic, orthorhombic, rhombohedral, tetragonal, whiskers and tubes.

In particular aspects, a portion of the high thermal conductivity fillers aggregate into secondary structures, where the aggregates are held together by chemical or physical bonding. Interconnection between secondary structures creates thermal conduction through the host resin matrix. The aggregate secondary structures form at least one of: stacks, spheroids, splayed spheres, sheets, dendritic stars and pearl necklaces. And up to 50-100% by weight of the high thermal conductivity fillers form secondary structures. Also, 5-50% of the high thermal conductivity fillers do not, or have limiting aggregation into secondary structures. These can act to bridge the aggregate formations. The fillers that do not form secondary structures are of a different type of filler than HTC fillers that form secondary structures. They may be chemically different, for example alumina based rather than boron nitride based, morphologically different, for example rods instead of discoids, or they may be surface treated to limit co-reactivity. Surface groups can also be present on the fillers for other purposes, such as for better co-reactivity of the resin. The aggregated fillers can also have surface groups to aid in aggregation.

In particular embodiments, the high thermal conductivity fillers comprise fillers that are decorated with nano fillers. This can be 5-10% by weight of the total nano-decorated filler. Multiple secondary structures can be formed within the same host resin matrix. The use of secondary structures can reduce or enhance viscosity. Smaller aggregates can reduce the viscosity, as will certain morphologies, such as a sphere. Bi and multi-modal mixing with different morphologies with high packing density may help to reduce viscosity, and increase thermal conductivity.

In specific embodiments at least some of the HTC fillers are hexagonal BN, which have length of approximately 50-200 nm. The hexagonal boron nitride fillers can aggregate into stacks, and smaller hexagonal BN fillers decorate larger hexagonal BN fillers. Complimentary fillers to BN are rod shaped.

In another aspect the present invention provides for a continuous organic-inorganic resin that comprises a host resin network, a first class and a second class of inorganic high thermal conductivity fillers. The first class is evenly dispersed in the host resin network and essentially completely co-reacted with the host resin network, and the second class is unevenly dispersed in the host resin network, and formed into aggregate into secondary structures. The high thermal conductivity fillers have a length of between 1-1000 nm and an average aspect ratio of 3-100, and are selected from at least one of oxides, nitrides, and carbides. At least a portion of the high thermal conductivity fillers comprise morphologies chosen from the group consisting of hexagonal, cubic, orthorhombic, rhombohedral, tetragonal, whiskers and tubes. In particular cases the ratio of the first class of fillers to the second class of fillers is between 3:1 to 10:1 by weight. The second class of fillers can self aggregate in some cases, or be at least in part aggregated by an external mechanism.

In some embodiments the host resin network is impregnated into a mica paper. In such cases the second class of fillers aggregate with greater concentration within voids in the mica paper. In other embodiments the high thermal conductivity fillers have been surface treated to introduce surface functional groups that allows for the essentially complete co-reactivity with the host resin network. In certain embodiments the continuous organic-inorganic resin comprises a maximum of 60% by volume of the high thermal conductivity fillers.

In one example the first class of filler is boron nitride and the second class of filler is alumina. Particularly good examples include the boron nitride comprising 15-30% by weight, and the alumina 3.5-10% by weight, of the total organic-inorganic resin composition.

Other embodiments of the present invention also exist, which will be apparent upon further reading of the detailed description.

### BRIEF DESCRIPTION OF THE FIGURES

The invention is explained in more detail by way of example with reference to the following drawings:

FIG. 1 shows the use of an insulating tape being lapped around a stator coil.

FIG. 2 illustrates a splayed sphere according to one embodiment of the present invention.

FIG. 3 illustrates a pearl necklace secondary structure according to one embodiment of the present invention.

FIG. 4 illustrates nano-decorated meso-particles according to one embodiment of the present invention.

FIG. 5 illustrates phonons traveling through a loaded resin of the present invention.

FIG. 6 illustrates heat flow through stator coils.

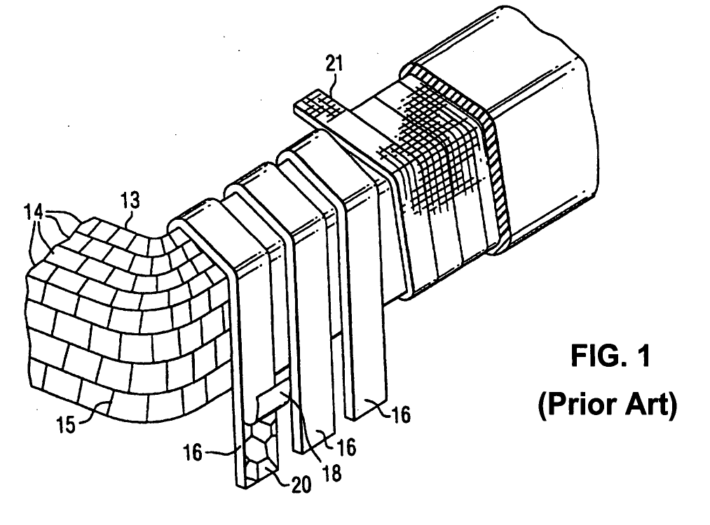

### DETAILED DESCRIPTION OF THE INVENTION

High thermal conductivity (HTC) composites comprise a resinous host network combined with fillers that are two phase organic-inorganic hybrid materials. The organic-inorganic hybrid materials are formed from two phase organic-inorganic composites, from organic-inorganic continuous phase materials that are based on molecular alloys, and from discrete organic-dendrimer composites in which the organic-inorganic interface is non-discrete with the dendrimer core-shell structure. Phonon transport is enhanced, and phonon scattering is reduced by ensuring the length scales of the structural elements are shorter than, or commensurate with, the phonon distribution responsible for thermal transport.

Two phase organic-inorganic hybrids may be formed by incorporating inorganic micro, meso or nano-particles in linear or cross linked polymers (thermoplastics) and thermosetting resins. Host networks include polymers and other types of resins, definitions of which are given below. In general, the resin that acts as a host network may be any resin that is compatible with the particles and, if required, is able to react with the groups introduced at the surface of the filler. Nano-particle dimensions are typically of the order of or less than the polymer network segmental length. For example 1-30 nm. The inorganic particles contain reactive surfaces to form covalently bonded hybrid organic-inorganic homogeneous materials. The particles may be oxides, nitrides, carbides and hybrid stoichiometric and non-stoichiometric mixes of the oxides, nitrides and carbides, more examples of which are given below.

The inorganic particles may be surface treated to introduce a variety of surface functional groups which are capable of participating in reactions with the host network. The surface functional groups include but are not limited to hydroxyl, carboxylic, amine, epoxide, silane and vinyl groups. The groups may be applied using wet chemical methods, non-equilibrium plasma methods, chemical vapor and physical vapor deposition, sputter ion plating and electron and ion beam evaporation methods.

The discrete organic-dendrimer composites may be reacted together or with the resin matrix to form a single material. The surface of the dendrimer can contain reactive groups similar to those mentioned above, which will either allow dendrimer-dendrimer or dendrimer-organic matrix reactions to occur. The dendrimer will have an inorganic core and an organic shell containing the reactive groups of interest. It may also be possible to have an organic core with an inorganic shell which also contains reactive groups such as hydroxyl or silane groupings which can participate in inorganic reactions similar to those involved in common sol-gel chemistries.

In regard to the use of non-discrete organic-inorganic hybrids, it is possible to use sol-gel chemistry to form a continuous molecular alloy. Gel sol-chemistries involving aqueous and non-aqueous reactions may be used. Other compounds for the formation of organic-inorganic hybrids include the polyhedral oligomeric silsesquioxanes (POSS), tetraethyl orthosilicate (TEOS) and tetrabutyl orthotitanate (TBOT) and related monomeric and oligomeric hybrid compounds which are organic functionalized inorganic compounds. In the example of POSS, molecules are built around a building block of R—SiO_{1.5} in which the R group is chosen to compatibilize with and/or react with other organic compounds and the host network. The base compounds may be combined to yield larger molecules commensurate with the size of polymer segment and coil structures. POSS may be used to create organic-inorganic hybrids and may be grafted into existing polymers and networks to control properties, including thermal conductivity. The materials may be obtained from suppliers such as Aldrich™ Chemical Co., Hybrid Plastics™ Inc. and Gelest™ Inc.

As mentioned, it is important to control the structural form of the materials to reduce phonon scattering. This can be further assisted by using nano-particles whose matrices are known to exhibit high thermal conductivity and to ensure that the particle's size and its interfacial characteristics with the resin are sufficient to sustain this effect, and also to satisfy the length scale requirement to reduce phonon scattering. A choice of structures that are more highly ordered will also benefit this, including reacted dendrimer lattices having both short and longer range periodicity and ladder or ordered network structures that may be formed from a host resin, such as liquid crystal epoxies and polybutadienes.

In one aspect the present invention provides for a filled resin, where the fillers are high thermal conductivity (HTC) particles, at least some of which have particular morphologies. Particles with high aspect ratios will tend to conduct heat, through reduced phonon scattering, along their length. However physical properties, including heat conduction, can be increased by using particular shapes of particles, or combinations of particular shapes. These shapes can have an impact on the level or amount of the individual particle used, or they can have an impact because of the way certain shapes tend to combine into aggregate secondary structures. In some cases, the shape of the particle may enhance physical properties through both its individual shape and through the aggregate structures.

The individual shapes of the particles can be the high aspect ratio rod, spheroidal, platelet, discoid and cuboid shapes discussed in U.S. patent application Ser. No. 11/152,985, “High Thermal Conductivity Materials Aligned Within Resins,” by Smith, et al. which is incorporated herein by reference. In addition, the structures of the individual particles can be chosen from the following: hexagonal, cubic, orthorhombic, rhombohedral, tetragonal, whiskers and tubes. The amount of HTC fillers that have these distinct morphologies can be upto the entire amount of HTC fillers used. Additionally, a mixture of morphologies can also be used, which will aid in interconnection and imparting localized structure.

Although the number of combinations between types of morphologies is numerous, it has been found that hexagonal platelet morphologies combined with rod and/or sphere morphologies have been complimentary. The mixed morphologies can then also have a size distribution, so that, for example, the hexagonal shapes can be represented in the micro, meso and nano ranges.

In dealing with morphologies, there needs to be a balance between connectivity/agglomeration and viscosity. Generally speaking, it is preferable to have high connectivity and low viscosity, such as a viscosity of between 30-50 centipoise which is primarily increased when particles aggregate into secondary structures.

When particles come together, a percentage of them will aggregate into secondary structures. A random selection of morphologies will produce a range of super structural forms or secondary structures, including stacks, sheets, spheroids, splayed spheres, sheets, dendritic stars and pearl necklaces. Certain secondary shapes, such as stacks, sheets and dendritic stars, can be tailored by using predominately certain base morphologies. For example, stacks can be formed using discoid shapes, sheets by using parallel platelets and dendritic stars by using rod/whisker/tubes. Spherodial aggregates can form from any small particles, but will primarily be formed from nano and meso platelets. Splayed spheres begin as a formed spheroid, such as from multiple stacks, that separate and the gaps caused by the separation are then filled with other HTC fillers.

The secondary structures will conduct heat through themselves at a much greater rate than dispersed particles. In addition, the secondary structures can increase viscosity, bridge thermal links to non aggregates and can even create dielectric barriers. Certain secondary structures, such as stacks are useful in non-planner packing. Since particle fillers are subject to lateral shears, secondary morphologies can be made that can tolerate certain levels of shearing; for example, parallel platelet stacking will have a higher shear strength than end-to-end packing. Given the degree of surface contact for parallel stacking, this enhances thermal conductivity for secondary structures.

A particular category of secondary structure is the decorated primary structure. This is when a primary morphology of a larger scale is decorated with similar or different morphologies of a smaller scale. For example, a hexagonal micro or meso sized particle may have dozens or even hundreds of nano sized hexagons, rods and/or spheroids disposed thereon.

Some secondary structures will interact with other secondary structures to form tertiary structures, an example of which being the pearl necklace shape discussed, which is a string-like collection of spheroids. Pseudo types of tertiary structures can also be formed where non aggregate fillers compliment secondary structures. For example, a series of aggregate spheroids which are spaced too far apart to be of the pear necklace category, can be connected by a dispersement of rod shaped fillers. In the case of a parallel stack, it would be beneficial to have large rod shaped fillers perpendicular to the stack to form additional interconnections.

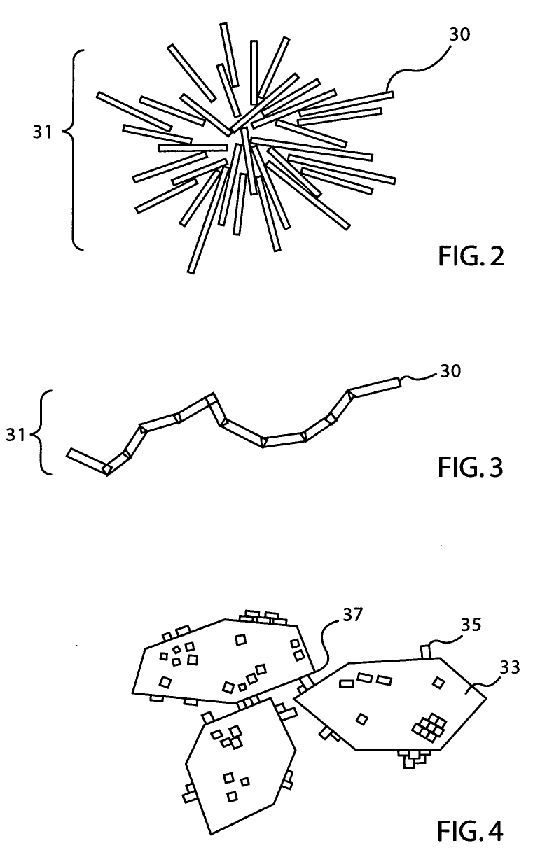

FIGS. 2 through 4 illustrate a variety of secondary structures 31 discussed. Referring to FIG. 2, the fillers materials, 30, which is shown here as a rod, but can also be a discoid, forms a splayed sphere. In some cases, additional particles, generally smaller than the particles that form the splayed sphere 30, will fill in the spaces within the splayed sphere to create a denser secondary structure. In FIG. 3 the secondary structure 31 is a pearl necklace composed of a link of rod shaped fillers.

FIG. 4 illustrates one example of a nano decorated 35 meso filler 33. In this figure, the meso structure is a hexagonal shaped filler, similar to how a meso hexagonal BN particle would appear. The nano decorations 35, can be of a similar morphology to the meso structure, or can be of their own morphology. The decorations can also serve to bridge 37 neighboring meso fillers.

A particular type of filler useful in forming particular morphologies is boron nitride. Boron nitride exists in several different crystallographic and morphological forms, which can be tailored to various extents. The shapes of the particles are directly related to the underlying crystallography so that the crystal form reflects the underlying unit cell structure. The unit cell structure arises from thermodynamic constraints as is known in the art. Single crystal particle morphology is usually directly related to the corresponding crystallography; other forms are also possible. Forms contemplated by the present invention include hexagonal and cubic, which can be produced by high temperature chemical processes. Other forms that can be made by low temperature chemical processes include orthorhombic, rhombohedral, and tetragonal. In addition, whiskers of boron nitride, an extremely fine filamentary crystal form, have also been produced commercially. Boron nitride nanotubes have also been produced by an impact ball milling mechanical process, from larger sized particles. Further, by special treatment, boron nitride meso or micro particles can be made to agglomerate into a spheroidal shape with sphere diameters typically in the 10 to 20 micron range.

The preferred size ranges of BN depends on the morphological form, as well as any secondary structures that are desired. Hexagonal and cubic BN in the 50-200 nm length range will thoroughly permeate a host resin matrix and many porous media, while hexagonal BN from 100 nm to several hundred microns will more readily stack together, forming secondary stack structures. These secondary structures can be favored by using a larger range of BN particles, and a greater concentration of BN. Hexagonal BN has a good shear modulus, which describes the ease with which it will yield to stress in the plane. It is also soft, which is reflecting in low compressional and shear modulus values. It is discoid in nature, and has strong dielectric barrier properties, with good heat conduction.

Boron nitride may also be combined with other materials such as alumina. The ratio of BN to alumina can be varied, but is optimally about 50% by weight. This type of mixing can form decorated platelets.

Different morphological shapes may confer different physical properties on the BN, but the particles will in general retain good electrical and thermal characteristics, i.e. very high dielectric strength and very high thermal conductivity. This makes it useful, in all its forms, for the manufacture of insulation materials for use in electrical and associated applications. All currently known crystallographic forms of BN will have good electrical and dielectric characteristics.

The thermal conductivity of composite materials incorporating BN materials can be significantly increased by orientation of those particles in, for example, an external electrical field. In such fields particle alignment and aggregation structures will influence the final properties, for example extended pearl necklace and dendritic forms may arise from both high and low aspect ratio particles when they form clustered bundles or rod-extended structures.

In regards to a tape or porous media, it is desirable to have particles that will form into secondary structures collect in void areas. In dealing with porous media such as a mica tape, it is desirable to have secondary structures form in these regions. The secondary structures will tend to self assemble in the void regions with sufficient concentration of the nano fillers. This can be done by pre-seeding in the mica paper, or in the back coating as described by Smith, et al in U.S. application Ser. No. 11/396,990, “Composite Insulation Tape with Loaded HTC Materials” which is incorporated herein by reference. The particles and particle clusters that tend to collect in the void regions will tend to be in the nano to meso scale range.

The filled resins may be used as bonding resins in a variety of industries such as circuit boards and insulating tapes. A particular kind of insulating tape is the mica-glass tape used in the electrical generator fields. Resins with these types of tapes can be used as bonding resins, or as impregnating resins as is known in the art. The filled resin may also be used in the electrical generator field without the tapes to fulfill electrical insulation applications in the rotating and static electrical equipment components.

The tapes may be impregnated with resin before or after being applied to electrical objects. Resin impregnation techniques include VPI and GVPI, discussed more below. In VPI, once a tape is lapped and impregnated it is compressed. Once in position, the resin in the compressed tape is cured, which effectively locks the position of the HTC materials. In some embodiments the resin is cured in a two stage process, as will be apparent to one of ordinary skill in the art. However, optimal compression of the loaded HTC materials favors a completely uncured resin during the compression stage.

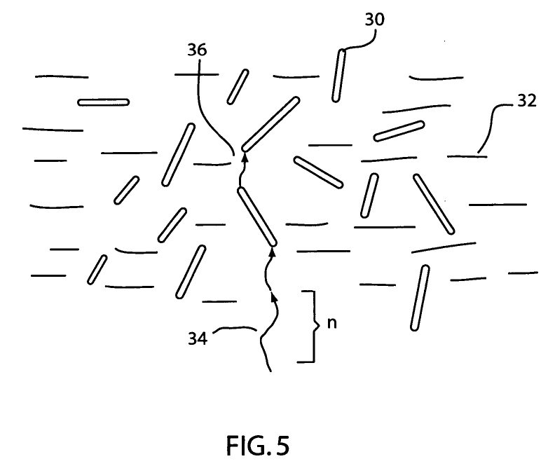

FIG. 5 shows one embodiment of the present invention. Illustrated here are HTC materials 30 loaded into a resinous matrix 32. Phonons 34 traveling through the matrix have a mean path length n, this is the phonon mean free path. This path length can vary depending on the exact composition of the resin matrix, but is generally from 2 to 100 nm, and more typically 5-50 nm, for resins such as epoxy resins. Therefore the mean distance between the loaded HTC materials should be on average less than this distance. Note that the distance between the HTC materials can vary in the thickness versus transverse direction of the tape, and it is generally the thickness direction where the spacing needs to be optimalized.

As phonons 34 travel through the resin 32 they will tend to pass along the embedded HTC materials 30. This will increase the local phonon flux since the raw HTC materials will have a thermal conductivity of between 10-1000 W/mK, as opposed to the resin which is about 0.1-0.5 W/mK. As phonons pass along a loaded HTC material the phonons 36 pass to the next HTC material if the distance between the materials is less than n, therefore the HTC materials form an interconnecting network. FIG. 5 illustrates an idealized path. In practice there will be phonon scattering as the phonons pass between the resin and HTC materials, although the shorter the distance between the materials, and the better the match of phonon propagation characteristics between the HTC materials and the resin, the less the scattering.

The amount of HTC materials loaded in the resin could actually be quite low, for example about 10% as illustrated in FIG. 5. The average distances, or length scales, between loaded HTC materials therefore may be slightly greater than n, however, a large percentage will still be less than n and therefore fall within embodiments of the present invention. In particular embodiment, the percentage materials that are less than n distance from the next HTC material is over 50%, with particular embodiment being over 75%. In particular embodiment the average length of the HTC materials is greater than n, which further aids in phonon transport.

The shorter n the greater the concentration of loaded HTC materials, and conversely, the greater the particle size, the less HTC materials needed. Particular embodiment use 5-60% loaded HTC materials by total volume of the resins and fillers, with more particular embodiments at 25-40%. When the resin is impregnated into the tape, it will fill up the spaces between the tape fibers and substrates. The HTC distribution within the tape at this point, however, is often not optimized, and can even have the mean distance between HTC materials greater than n. Practice of the present invention then compresses the resin impregnated tapes and reduces the distances between the loaded HTC materials.

Single HTC filler materials can be used in this manner, not only to independently connect thermal pathways through the host matrix, but also to connect aggregated secondary structures. The aggregated secondary structures have high thermal conduction properties, but since they are formed of aggregates, the materials that form the aggregates will often be at a significantly reduced concentration between the particles. The aggregates themselves are often spaced apart at distances greater than n. By interspersing non-aggregated fillers, or limited aggregated fillers (such as 1-5% by weight), they can act to bridge the matrix between the aggregated secondary structures. Limited aggregates are very small aggregates that can be on the meso and nano scale. The ratio of aggregated fillers to non aggregates will be higher, from 3:1 to 10:1 by weight.

When a loaded resin is being impregnated into a tape, the fibers or particles of the tape act to block some of the HTC materials, particularly if the resin is 30% or more filler. However, by compressing the tapes, the reverse happens, and more fillers are trapped within the tape as the HTC materials attach themselves to non-mobile parts of the overall structure. The HTC fillers even get pinned to one another. In the embodiments given, it has been implied that the fillers do not react with the resin matrix, however, in some embodiments the fillers do form covalent bonds with the resin and form more homogeneous matrixes. In a homogenous matrix, the resin molecules that are bound to fillers will be retained better than the unbound resin molecules during compression.

Resins are used in a plurality of industries, and have a large number of uses. Different properties of the resins affect not only their uses, but also the quality and efficiency of the products that they are used with. For example, when resins are used in electrical insulation applications, their characteristics of dielectric strength and voltage endurance needs to be high, as does the thermal stability and thermal endurance. However, often contrary to these objectives, resins usually will also have a low thermal conductivity. The present invention balances the various physical properties of resins and the insulation system they are introduced into to produce a system that has a higher thermal conductivity than conventional electrically insulating materials while maintaining adequate, and even enhancing, key physical properties such as dielectric strength, voltage endurance, thermal stability and thermal endurance, mechanical strength and viscoelastic response. Delamination and microvoid formation resulting from stresses caused by thermal and mechanical cycling effects are reduced or eliminated. As used herein, the term resin refers to all resins and epoxy resins, including modified epoxies, polyesters, polyurethanes, polyimides, polyesterimides, polyetherimides, bismaleimides, silicones, polysiloxanes, polybutadienes, cyanate esters, hydrocarbons etc. as well as homogeneous blends of these resins. This definition of resins includes additives such as cross-linking agents, accelerators and other catalysts and processing aids. Certain resins, such as liquid crystal thermosets (LCT) and 1,2 vinyl polybutadiene combine low molecular weights characteristics with good crosslinking properties. The resins can be of an organic matrix, such as hydrocarbons with and without hetero atoms, an inorganic matrix, containing silicate and/or alumino silicate components, and a mixture of an organic and inorganic matrix. Examples of an organic matrix include polymers or reactive thermosetting resins, which if required can react with the reactive groups introduced on inorganic particle surfaces. Cross-linking agents can also be added to the resins to manipulate the structure and segmental length distribution of the final crosslinked network, which can have a positive effect on thermal conductivity. This thermal conductivity enhancement can also be obtained through modifications by other resin additives, such as catalysts, accelerators and other processing aids. Certain resins, such as liquid crystal thermosets (LCT) and 1,2 vinyl polybutadiene combine low molecular weights characteristics with good crosslinking properties. These types of resins tend to conduct heat better because of enhanced micro and macro ordering of their sub-structure which may lead to enhanced conduction of heat as a result of improved phonon transport. The better the phonon transport, the better the heat transfer.

When the high thermal conductivity fillers of the present invention are mixed with resins they form a continuous product, in that there is no interface between the resins and the fillers. In some cases, covalent bonds are formed between the fillers and the resin. However, continuous is somewhat subjective and depends on the scale to which the observer is using. On the macro-scale the product is continuous, but on the nano-scale there can still be distinct phases between the fillers and the resin network. Therefore, when referring high thermal conductivity fillers mixing with the resin, they form a continuous organic-inorganic composite, on the macro-scale, while on the micro-scale the same mixture can be referred to as a hybrid.

As mentioned, filled resin may be used in the electrical generator field without the tapes to fulfill electrical insulation applications in the rotating and static electrical equipment components. The use of high thermal conductivity materials in a generator is multiple. Within the stator coil there are component materials other than the groundwall which must have high thermal conductivity to optimize the design. Likewise other components associated with the coils to maximize heat removal. Improvements to stator design dictate that improvements be made to rotor design so that generator efficiency can by maximized.

Examples of these places components and materials to which the high thermal conductivity technology described herein can be applied in a stator include inter-strand insulation, internal corona protection (ICP) systems, outer corona protection (OCP) systems, bottom, center, and top fillers including packing and prestressed driving strips (PSDS—top ripple springs); side fillers, laminates, and side PSDS, coil center separator or sword, coil transposition filler, stator wedge, core insulation, diamond spacers, braces or brackets, end-winding bonding resin and compressible gap fillers, connector insulation, parallel ring insulation and parallel ring support structure. In a rotor examples include cell or slot liner, interturn insulation, turn and ground insulation where integral, end cap insulation, blocking, radial pins and leads and slot top packer or “U”.

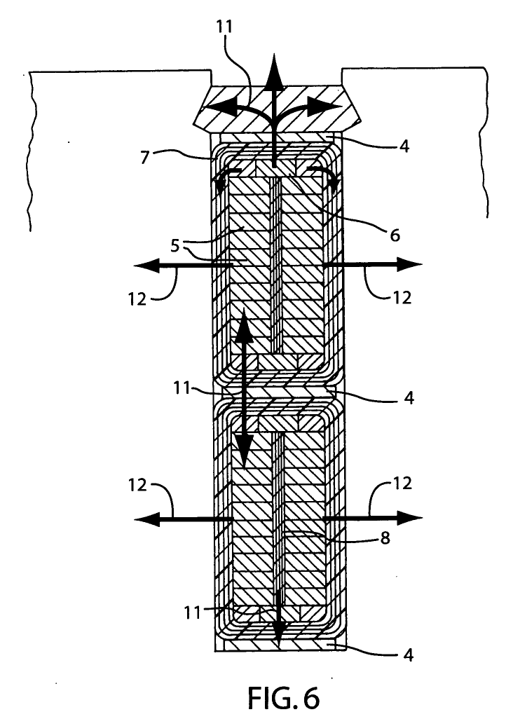

For clarity, reference is made to FIG. 6, showing a cross sectional view of the heat flow 11, 12, through stator coils, 12 being the main flow through the groundwall. The stator coil depicted by this figures includes copper stands 5, transposed strands 6, bottom, center, and top fillers 4, groundwall insulation 7, and center separator 8, among other parts.

The components or materials described above may be produced by a variety of means, including laminating, extrusion, molding, and other processes with which one experienced in the art will be familiar. The construction materials used in a stator coil are copper and insulation. The copper is in the form of strands which are generally insulated, assembled, and converted into a bakelized coil or stack. The bakelized coil is insulated with groundwall insulation, but there are electrical stress control layers associated with it. The major component affecting the thermal conductivity of the stator coil is the groundwall insulation, but other components benefit from being similarly improved. For example the stress control and other systems employed in the construction of stator coils can typically be of from 10 to 20% of the insulation thickness from copper to stator core. In some instances it is proposed to tune the thermal and electrical conductivities to the desired values by introducing structural changes to the materials.

By way of further example, an internal stress control layer may consist of a low conductivity layer, which may be connected to the copper directly or through resistance, or insulated from it. In such instances an insulating layer may be applied to the bakelized coil surface before the low conductivity layer is applied. An insulating tape or sheet may be applied onto the bakelized coil for the purpose of bonding or for smoothing of the surface to fill in void areas. Then an additional layer or layers of material having the required properties may be applied after the low conductivity layer. This may be for electrical purposes such as stress control or insulation.

After the groundwall is applied a low conductivity layer(s) is applied to the surface of the coil to ensure a good connection to the core, to obviate partial discharge and bar bounce effects while avoiding shorting core laminations. An application in which this low conductivity layer has an insulating layer applied over it has also been described in patent literature. The outer corona protection system may therefore include low conductivity, insulating, and part insulating layers.

To control the electrical stress in the stator end region a stress control layer is applied at the ends of the coil straight portion and into the endwindings or involute region. This normally consists of a silicon carbide loaded tape or paint, applied in one or several layers, sometimes stepped layers. It may also be combined with an insulating layer or a relatively high resistivity layer(s). In this application the high thermal conductivity materials will significantly enhance the thermal conductivity of the system. The choice of when to use a high thermal conductivity material will depend on the machine design and the thermal conductivity properties of the normal insulating material and of the groundwall.

In the end region glass tapes and shrink materials are used in certain types of design, for various functions such as consolidation and to enhance mechanical bracing. In addition the mechanical bracing of the endwinding region involves the use of resins, diamond spacers, conformable impregnateable materials such as felts or cloths, and materials into which resin can be loaded such as bags, bladders or hoses. In these components and materials the use of high thermal conductivity materials will significantly enhance the thermal conductivity of the system. The choice of where and when to use a high thermal conductivity material will depend on the machine design and the thermal conductivity properties of the normal insulating material.

In direct cooled rotors the cooling gas or medium is in direct contact with the copper. There are two main designs for direct cooling—radial cooling and axial cooling. The endwinding region may have a different method of cooling. In the radial cooled design the gas passes along a sub-slot or hollow turn at the bottom of each slot. It then passes radially through cooling slots in the solid copper turns and exhausts at the top of the slot. In the axial cooled design the turns are hollow and usually square or rectangular in cross section. Gas enters at each end through holes in the side walls of the hollow conductors and passes along the inside of the copper tubes, exhausting radially through holes in the copper at the rotor center.

In both these designs of rotor the effects of using high thermal conductivity materials on the design is significant. Indeed it may be more significant in indirectly cooled machines. The rotor coils are insulated from ground typically by molded epoxy glass laminates in the form of either slot cells or angles. Interturn insulation may be laminate or angles. It can be appreciated that such components can be made highly thermally conducting by the use of the methods described herein.

One embodiment of the present invention adds high thermal conductivity (HTC) materials to resins to improve the thermal conductivity of the resins. In some embodiments the other physical properties of the resins are reduced in a trade-off with higher thermal conductivity, but in other embodiments, some of the other physical properties will not be significantly affected, and in some particular embodiments these other properties will be improved. In particular embodiments, the HTC materials are added to resins, such as LCT epoxy, that have ordered sub-structures. When added to these types of resins, the amount of HTC material used can be reduced versus use in resins without ordered sub-structures.

The HTC materials loaded into the resins are of a variety of substances that can be added so that they may physically and/or chemically interact with or react with the resins to improve thermal conductivity. In one embodiment, the HTC materials are dendrimers, and in another embodiment they are nano or micro inorganic fillers having a defined size or shape including high aspect ratio particles with aspect ratios (ratio mean lateral dimension to mean longitudinal dimension) of 3 to 100 or more, with a more particular range of 10-50.

In a related embodiment, the HTC materials may have a defined size and shape distribution. In both cases the concentration and relative concentration of the filler particles is chosen to enable a bulk connecting (or so-called percolation) structure to be achieved which confers high thermal conductivity with and without volume filling to achieve a structurally stable discrete two phase composite with enhanced thermal conductivity. In another related embodiment, the orientation of the HTC materials increases thermal conductivity. In still another embodiment, the surface coating of the HTC materials enhances phonon transport. These embodiments may stand apart from other embodiments, or be integrally related. For example, dendrimers are combined with other types of highly structured materials such as thermoset and thermoplastic materials. They are uniformly distributed through a resin matrix such that the HTC materials reduce phonon scattering and provide micro-scale bridges for phonons to produce good thermally conducting interfaces between the HTC materials. The highly structured materials are aligned so that thermal conductivity is increased along a single direction or directions to produce either localized or bulk anisotropic electrically insulating materials. In another embodiment HTC is achieved by surface coating of lower thermal conductivity fillers with metal oxides, carbides or nitrides and mixed systems having high thermal conductivity which are physically or chemically attached to fillers having defined bulk properties, such attachment being achieved by processes such as chemical vapour deposition and physical vapour deposition and also by plasma treatment.

In related embodiments, the HTC materials form essentially homogenous mixtures with the resins, essentially free of undesired microscopic interfaces, variable particle wetting and micro void formation. These homogeneous materials form a continuous-phase material which are non-discrete at length scales shorter than either the phonon wavelength or phonon mean free path in conventional electrical insulating materials. In some embodiments, intentional interfaces can be placed in the resin structure so as to control dielectric breakdown. In insulating materials, dielectric breakdown will occur given the right conditions. By controlling the nature and spatial distribution of the interfaces in two-phase system, dielectric breakdown strength and long term electrical endurance can be enhanced. Increases in dielectric strength will take place in part because of increased densification, the removal of micro voids and a higher level of internal mechanical compression strength.

Resins of the present invention may be used for impregnation of other composite constructions such as a mica tape and glass and polyester tape. In addition to the standard mica (Muscovite, Phlogopite) that is typically used for electrical insulation there is also Biotite mica as well as several other mica-like Alumino-Silicate materials such as Kaolinite, Halloysite, Montmorillonite and Chlorite. Montmorillonite has lattices in its structure which can be readily intercalated by polymer resins, metal cations and nano particles to give high dielectric strength composites.

In other embodiments, the present invention is used as a continuous coating on surfaces where insulation is desired; note that “continuous coating” is a description of a macro-scale application. In a continuous coating, the resin forms a coating on materials without the need for a tape or other substrate. When used with a substrate, the HTC materials can be combined with the resin by a variety of different methods. For example, they can be added prior to the resin being added to the substrate, or the HTC materials can be added to the substrate before the resin is impregnated thereon, or the resin can be added first, followed by the HTC material and then an additional impregnation of resin. Other fabrication and process methods will be apparent to one of ordinary skill in the art.

In one embodiment the present invention uses novel organic-inorganic materials which offer higher thermal conductivity and also maintain or enhance other key properties and performance characteristics. Such materials have applications in other high voltage and low voltage electrical insulation situations where high thermal conductivity confers advantage in terms of enhanced power rating, reduced insulation thickness, more compact electrical designs and high heat transfer. The present invention adds nano, meso, and micro inorganic HTC-materials such as alumina, magnesium oxide, silicon carbide, boron nitride, aluminium nitride, zinc oxide and diamond, as well as others, to give higher thermal conductivity. These materials can have a variety of crystallographic and morphological forms and they may be processed with the matrix materials either directly or via a solvent which acts as a carrier liquid. The solvent mixture may be used to mix the HTC-materials into the matrix to various substrates such as mica-tape. In contrast, molecular hybrid materials which form another embodiment of the present invention, do not contain discrete interfaces, and have the advantages conferred by an inorganic phase within an organic. These materials may also confer enhancement to other physical properties such as thermal stability, tensile strength, flexural strength, and impact strength, variable frequency and temperature dependant mechanical moduli and loss and general viscoelastic response, etc.

In another embodiment, the present invention comprises discrete organic-dendrimer composites in which the organic-inorganic interface is non-discrete with a dendrimer core-shell structure. Dendrimers are a class of three-dimensional nanoscale, core-shell structures that build on a central core. The core may be of an organic or inorganic material. By building on a central core, the dendrimers are formed by a sequential addition of concentric shells. The shells comprise branched molecular groups, and each branched shell is referred to as a generation. Typically, the number of generations used is from 1-10, and the number of molecular groups in the outer shell increase exponentially with the generation. The composition of the molecular groups can be precisely synthesized and the outer groupings may be reactive functional groups. Dendrimers are capable of linking with a resin matrix, as well as with each other. Therefore, they may be added to a resin as an HTC material, or, in other embodiments, may form the matrix themselves without being added to traditional resins.

The molecular groups can be chosen for their ability to react, either with each other or with a resin. However, in other embodiments, the core structure of the dendrimers will be selected for their own ability to aid in thermal conductivity; for example, metal oxides as discussed below.

Generally, the larger the dendrimer, the greater its ability to function as a phonon transport element. However, its ability to permeate the material and its percolation potential can be adversely affected by its size so optimal sizes are sought to achieve the balance of structure and properties required. Like other HTC materials, solvents can be added to the dendrimers so as to aid in their impregnation of a substrate, such as a mica or a glass tape. In many embodiments, dendrimers will be used with a variety of generations with a variety of different molecular groups.

Commercially available organic Dendrimer polymers include Polyamido-amine Dendrimers (PAMAM) and Polypropylene-imine Dendrimers (PPI) and PAMAM-OS which is a dendrimer with a PAMAM interior structure and organo-silicon exterior. The former two are available from Aldrich Chemical™ and the last one from Dow-Corning™.

Similar requirements exist for inorganic-organic dendrimers which may be reacted together or with matrix polymers or reactive resins to form a single material. In this case the surface of the dendrimer could contain reactive groups similar to those specified above which will either allow dendrimer-dendrimer, dendrimer-organic, dendrimer-hybrid, and dendrimer-HTC matrix reactions to occur. In this case the dendrimer will have an inorganic core and an organic shell, or vice-versa containing either organic or inorganic reactive groups or ligands of interest. It is therefore also possible to have an organic core with an inorganic shell which also contains reactive groups such as hydroxyl, silanol, vinyl-silane, epoxy-silane and other groupings which can participate in inorganic reactions similar to those involved in common sol-gel chemistries.

In all cases phonon transport is enhanced and phonon scattering reduced by ensuring the length scales of the structural elements are shorter than or commensurate with the phonon distribution responsible for thermal transport. Larger HTC particulate materials can actually increase phonon transport in their own right, however, smaller HTC materials can alter the nature of the resin matrix, thereby affect a change on the phonon scattering. This may be further assisted by using nano-particles whose matrices are known to exhibit high thermal conductivity and to ensure that the particle size and interface characteristics are sufficient to sustain this effect and also to satisfy the length scale requirements for reduced phonon scattering. It is also necessary to consider the choice of structures that are more highly ordered including reacted dendrimer lattices having both short and longer range periodicity and ladder or ordered network structures that may be formed from matrices such as liquid crystal epoxy resins and polybutadienes. A resin matrix of the prior art will have a maximum thermal conductivity of about 0.15 W/mK. The present invention provides resins with a thermal conductivity of 0.5 to 5 W/mK and even greater.

Continuous organic-inorganic hybrids may be formed by incorporating inorganic nano-particles in linear or crosslinked polymers and thermosetting resins in which nano-particles dimensions are of the order of or less than the polymer or network segmental length (typically 1 to 50 nm). This would include, but is not exclusive to three routes or mechanisms by which this can occur (i) side chain grafting, (ii) inclusive grafting e.g. between two polymer chain ends, (iii) cross-link grafting involving at least two and typically several polymer molecules. These inorganic nano-particles will contain reactive surfaces to form intimate covalently bonded hybrid organic-inorganic homogeneous materials. These nano-particles may be metal oxides, metal nitrides, and metal carbides, as well as some non-metal oxides, nitrides and carbides. For example, alumina, magnesium oxide and zinc oxide and other metal oxides, boron nitride and aluminum nitride and other metal nitrides, silicon carbide and other carbides, diamond of natural or synthetic origin, and any of the various physical forms of each type and other metal carbides and hybrid stoichiometric and non-stoichiometric mixed oxides, nitrides and carbides. More specific examples of these include Al₂O₃, AlN, MgO, ZnO, BeO, BN, Si₃N₄, SiC and SiO₂ with mixed stoichiometric and non-stoichiometric combinations. Further, these nano-particles will be surface treated to introduce a variety of surface functional groups which are capable of participating in reactions with the host organic polymer or network. It is also possible to coat non-HTC materials, such as silica and other bulk filler materials, with an HTC material. This may be an option when more expensive HTC materials are used.

The volume percentage of the HTC materials in the resin may be up to approximately 60% or more by volume, and more particularly up to approximately 35% by volume. Higher volume filling tends to give higher structural stability to a matrix. However, with control of the size and shape distribution, degree of particle association and alignment the HTC materials can occupy as little as 1% by volume or less. Although, for structural stability reasons, it might be useful to add an amount greater than the minimum needed for percolation to occur. Therefore the resin can withstand physical strains and deformation without damaging the percolation structure and the HTC characteristics.

The addition of surface functional groups may include hydroxyl, carboxylic, amine, epoxide, silane or vinyl groups which will be available for chemical reaction with the host organic polymer or network forming resin system. These functional groups may be naturally present on the surface of inorganic fillers or they may be applied using wet chemical methods, non-equilibrium plasma deposition including plasma polymerization, chemical vapour and physical vapour deposition, sputter ion plating and electron and ion beam evaporation methods. The matrix polymer or reactive resin may be any system which is compatible with the nano-particles and, if required, is able to react with the reactive groups introduced at the nano-particle surface. These may be epoxy, polyimide epoxy, liquid crystal epoxy, cyanate-ester and other low molecular weight polymers and resins with a variety of crosslinking agents.

In the case of non-discrete organic-inorganic hybrids it is possible to use sol-gel chemistry to form a continuous molecular alloy. In this case sol-gel chemistries involving aqueous and non-aqueous reactions may be considered.

The products of the present invention exhibit higher thermal conductivity than conventional electrically insulating materials and may be used as bonding resins in mica-glass tape constructions, as unreacted vacuum-pressure impregnation resins for conventional mica tape constructions and as stand alone materials to fulfill electrical insulation applications in rotating and static electrical power plant and in both high and low voltage electrical and electronic equipment, components and products. Products of the present invention may be combined with each other, as well as HTC-material, and other materials, of the prior art.

Micro and nano HTC particles may be selected on their ability to self aggregate into desired structural, filaments and branched dendrites. Particles may be selected for their ability to self-assemble naturally, though this process may also be modified by external forces such as an electric field, magnetic field, sonics, ultra-sonics, pH control, use of surfactants and other methods to affect a change to the particle surface charge state, including charge distribution, of the particle. In a particular embodiment, particles such as boron nitride, aluminum nitride, diamond are made to self assemble into desired shapes. In this manner, the desired aggregation structures can be made from highly thermally conductive materials at the outset or assembled during incorporation into the host matrix.

In many embodiments, the size and shape of the HTC-materials are varied within the same use. Ranges of size and shape are used in the same product. A variety of long and shorter variable aspect ratio HTC-materials will enhance the thermal conductivity of a resin matrix, as well as potentially provide enhanced physical properties and performance. One aspect that should be observed, however, is that the particle length does not get so long as to cause bridging between layers of substrate/insulation. Also, a variety of shapes and length will improve the percolation stability of the HTC-materials by providing a more uniform volume filing and packing density, resulting in a more homogeneous matrix. When mixing size and shapes, in one embodiment the longer particles are more rod-shaped, while the smaller particles are more spheroidal, platelet or discoid and even cuboids. For example a resin containing HTC-materials could contain about 55-65% by volume 10-50 nm diameter spheroids and about 15-25% by volume 10-50 μm length rods, with 10-30% volume resin.

In another embodiment the present invention provides for new electrical insulation materials based on organic-inorganic composites. The thermal conductivity is optimized without detrimentally affecting other insulation properties such as dielectric properties (permittivity and dielectric loss), electrical conductivity, electric strength and voltage endurance, thermal stability, tensile modulus, flexural modulus, impact strength and thermal endurance in addition to other factors such as viscoelastic characteristics and coefficient of thermal expansion, and overall insulation. Organic and inorganic phases are constructed and are selected to achieve an appropriate balance of properties and performance.

In one embodiment the surface coating of nano, meso and micro inorganic fillers having the desired shape and size distribution and the selected surface characteristics and bulk filler properties are complimentary to each other. This enables the percolation structure of the filler phase in the organic host and the interconnection properties to be controlled independently while maintaining required bulk properties. In addition organic and inorganic coatings, as singular or secondary coatings may be used to ensure compatibilisation of the particle surfaces with the organic matrix and allow chemical reactions to occur with the host organic matrix.

In regards to shape, the present invention utilizes individual particle shapes tending towards natural rods and platelets for enhanced percolation, with rods being the most preferred embodiment including synthetically processed materials in addition to those naturally formed. A rod is defined as a particle with a mean aspect ratio of approximately 5 or greater, with particular embodiments of 10 or greater, though with more particular embodiments of no greater than 100. In one embodiment, the axial length of the rods is approximately in the range 10 nm to 100 microns. Smaller rods will percolate a resin matrix better, and have less adverse effect on the viscosity of the resin.

Many micro and nano particles form spheroidal and discoid shapes, which have reduced ability to distribute evenly under certain conditions and so may lead to aggregated filamentary structures that reduce the concentration at which percolation occurs. By increasing the percolation, the thermal properties of the resin can be increased, or alternately, the amount of HTC material that needs to be added to the resin can be reduced. Also, the enhanced percolation results in a more even distribution of the HTC materials within the resin rather than agglomeration which is to be avoided, creating a more homogenous product that is less likely to have undesired interfaces, incomplete particle wetting and micro-void formation. Likewise aggregated filamentary or dendritic structures, rather than globular (dense) aggregates or agglomerates, formed from higher aspect ratio particles confer enhanced thermal conductivity.

Additionally, fluid flow fields and electric and magnetic fields can be applied to the HTC materials to distribute and structurally organize them inside of the epoxy resin. By using alternating or static electric fields, the rod and platelet shapes can be aligned on a micro-scale. This creates a material that has different thermal properties in different directions. The creation of an electric field may be accomplished by a variety of techniques known in the art, such as by attaching electrodes across an insulated electrical conductor or by use of a conductor in the centre of a material or the insulation system.

Organic surface coatings, and inorganic surface coatings such as, metal-oxide, -nitride, -carbide and mixed systems may be generated which, when combined with the selected particle size and shape distribution, provide a defined percolation structure with control of the bulk thermal and electrical conductivity of the insulation system while the particle permittivity may be chosen to control the permittivity of the system. Another type of coating is micro-particulate and nano-particulate diamond coatings and of natural or synthetic origin. In poly-crystalline and mono-crystalline nano-particulate form, the particles may associate with the surface of a carrier particle, eg silica. Silica by itself is not a strong thermally conducting material, but with the addition of a surface coating it becomes more of a higher thermal conductivity material. Silica and other such materials, however, have beneficial properties such as being readily formed into rod-shaped particles, as discussed above. In this manner, various HTC properties can be combined into one product. These coatings may also have application to mica tape structures, including both the mica and the glass components, with or without resin impregnation.

Reactive surface functional groups may be formed from surface groups intrinsic to the inorganic coating or may be achieved by applying additional organic coatings both of which may include hydroxyl, carboxylic, amine, epoxide, silane, vinyl and other groups which will be available for chemical reaction with the host organic matrix. These single or multiple surface coatings and the surface functional groups may be applied using wet chemical methods, non-equilibrium plasma methods including plasma polymerization and chemical vapour and physical vapour deposition, sputter ion plating and electron and ion beam evaporation methods.

In another embodiment the present invention provides for new electrical insulation systems based on organic-inorganic composites. The interface between the various inorganic and organic components is made to be chemically and physically intimate to ensure a high degree of physical continuity between the different phases and to provide interfaces which are mechanically strong and not prone to failure during the operation of the electrical insulation system in service in both high and low voltage applications. Such materials have applications in high voltage and low voltage electrical insulation situations where enhanced interfacial integrity would confer advantage in terms of enhanced power rating, higher voltage stressing of the insulation systems, reduced insulation thickness and would achieve high heat transfer.

A particular embodiment uses a variety of surface treatments, nano, meso and micro inorganic fillers, so as to introduce a variety of surface functional groups which are capable of compatibilizing the inorganic surface with respect to the organic matrix or to allow chemical reactions to occur with the host organic matrix. These surface functional groups may include hydroxyl, carboxylic, amine, epoxide, silane or vinyl groups which will be available for chemical reaction with the host organic matrix. These functional groups may be applied using wet chemical methods, non-equilibrium plasma methods, chemical vapour and physical vapour deposition, laser beams, sputter ion plating and electron and ion beam evaporation methods.

In many embodiments, the surface treated materials may be used in bonding resins in mica-glass tape constructions, in unreacted vacuum-pressure impregnation (GVPI & VPI) resins for conventional mica tape constructions and in stand alone electrical insulation coatings or bulk materials to fulfill either electrically insulating or conducting applications in rotating and static electrical power plant and in both high and low voltage electrical equipment, components and products. Also, all chemical reactions should be the result of addition, and not condensation reactions so as to avoid volatile by-products.

Improvements in epoxy resins have recently been made by using liquid crystal polymers. By mixing an epoxy resin with a liquid crystal monomer or by incorporating a liquid crystalline mesogen into an epoxy resin molecule such as DGEBA, a liquid crystal thermoset (LCT) epoxy resin is produced that contains polymers or monomers that can be cross-linked to form ordered networks having significantly improved mechanical properties. See U.S. Pat. No. 5,904,984, which is incorporated herein by reference. A further benefit of LCTs is that they also have improved thermal conductivity over standard epoxy resins, and lower coefficient of thermal expansion (CTE) values as well.

What makes LCT epoxy resins even more appealing is that they are also better able to conduct heat than a standard epoxy resin. U.S. Pat. No. 6,261,481, which is incorporated herein by reference, teaches that LCT epoxy resins can be produced with a thermal conductivity greater than that of conventional epoxy resins. For example, a standard Bisphenol A epoxy is shown to have thermal conductivity values of 0.18 to 0.24 watts per meter degree Kelvin (W/mK) in both the transverse (plane) and thickness direction. By contrast, an LCT epoxy resin is shown to have a thermal conductivity value, when used in practical applications, of no more than 0.4 W/mK in the transverse direction and up to 0.9 W/mK in the thickness direction.

As used in reference to HTC materials being applied to paper, the term substrate refers to the host material that the insulating paper is formed from, while paper matrix refers to the more complete paper component made out of the substrate. These two terms may be used somewhat interchangeable when discussing this embodiment of the present invention. The increase of thermal conductivity should be accomplished without significantly impairing the electrical properties, such as dissipation factor, or the physical properties of the substrate, such as tensile strength and cohesive properties. The physical properties can even be improved in some embodiments, such as with surface coatings. In addition, in some embodiments the electrical resistivity of the host paper matrix can also be enhanced by the addition of HTC materials.

In addition to the standard mica (Muscovite,Phlogopite) that is typically used for electrical insulation there is also Biotite mica as well as several other Mica-like Alumino-Silicate materials such as Kaolinite, Halloysite, Montmorillonite and Chlorite. Montmorillonite has lattices in its structure which can be readily intercalated with HTC materials such as metal cations, organic compounds and monomers and polymers to give high dielectric strength composites.

Insulating papers are just one type of porous media that may be impregnated with the resin of the present invention. Many other materials and components made therefrom, in many industries, some of which are mentioned below, can use different types of porous media to impregnate the resin into. By way of examples there are glass fiber matrix or fabric, and polymer matrix or fabric, where the fabric might typically be cloth, matt, or felt. Circuit boards, which are glass fabric laminate, with planar lamination, will be one product which will benefit from the use of resins of the present invention.

Types of resin impregnation used with stator coils are known as VPI and GVPI. Tape is wrapped around the coil and then impregnated with low viscosity liquid insulation resin by vacuum-pressure impregnation (VPI). That process consists of evacuating a chamber containing the coil in order to remove air and moisture trapped in the mica tape, then introducing the insulation resin under pressure to impregnate the mica tape completely with resin thus eliminating voids, producing resinous insulation in a mica host. A compression of about 20% is particular to the VPI process in some embodiments. After this is completed, the coils are heated to cure the resin. The resin may contain an accelerator or the tape may have one in it. A variation of this, global VPI (GVPI) involves the process where dry insulated coils are wound, and then the whole stator is vacuum pressure impregnated rather than the individual coils. In the GVPI process, the coils are compressed prior to impregnation with the resin since the dry coils are inserted into their final position prior to impregnation. Although various compression methods have been discussed above, it is also possible to use the VPI/GVPI impregnating process for the actual compression stage of the present invention.

In one aspect the present invention provides for a high thermal conductivity resin that comprises a host resin matrix, and a high thermal conductivity filler. The high thermal conductivity filler forms a continuous organic-inorganic composite with the host resin matrix, and is from 1-1000 nm in length, has an average aspect ratio of between 3-100, and more particularly 10-50, although aspect ratios of specific particles can be outside of this average. A portion of the high thermal conductivity fillers comprise morphologies chosen from one or more of hexagonal, cubic, orthorhombic, rhombohedral, tetragonal, whiskers and tubes.

In particular aspects a portion of the high thermal conductivity fillers aggregate into secondary structures, where the aggregates are held together by chemical or physical bonding. Interconnection between secondary structures create thermal conduction through the host resin matrix. The aggregate secondary structures form at least one of stacks, spheroids, splayed spheres, sheets, dendritic starts and pearl necklaces. And up to 50-100% by weight of the high thermal conductivity fillers form secondary structures. Also, 5-50% of the high thermal conductivity fillers do not, or have limiting aggregation into secondary structures. These can act to bridge the aggregate formations. The fillers that do not form secondary structures are of a different type of filler than HTC fillers that form secondary structures. They may be chemically different, for example alumina based rather than boron nitride based, morphologically different, for example rods instead of discoids, or they may be surface treated to limit co-reactivity. Surface groups can also be present on the fillers for other purposes, such as for better co-reactivity of the resin. The aggregated fillers can also have surface groups to aid in aggregation.

In particular embodiments, the high thermal conductivity fillers comprise fillers that are decorated with nano fillers. This can be 5-10% by weight of the total nano-decorated filler. Multiple secondary structures can be formed within the same host resin matrix. The use of secondary structures can reduce or enhance viscosity. Smaller aggregate can reduce the viscosity, as will certain morphologies, such as a sphere. In general, bi and multi-modal mixing with different morphologies with high packing density may help to reduce viscosity, and increase thermal conductivity.

In specific embodiments at least some of the HTC fillers are hexagonal BN, which have length of approximately 50-200 nm. The hexagonal boron nitride fillers can aggregate into stacks, and smaller hexagonal BN fillers decorate larger hexagonal BN fillers. Complimentary fillers to BN are rod shaped.

In another aspect the present invention provides for a continuous organic-inorganic resin that comprises a host resin network, a first class and a second class of inorganic high thermal conductivity fillers. The first class is evenly dispersed in the host resin network and essentially completely co-reacted with the host resin network, and the second class is unevenly dispersed in the host resin network, and formed into aggregate into secondary structures. The high thermal conductivity fillers have a length of between 1-1000 nm and an average aspect ratio of 3-100, and are selected from at least one of oxides, nitrides, and carbides. At least a portion of the high thermal conductivity fillers comprise morphologies chosen from the group consisting of hexagonal, cubic, orthorhombic, rhombohedral, tetragonal, whiskers and tubes. In particular cases the ratio of the first class of fillers to the second class of fillers is between 3:1 to 10:1 by weight. The second class of fillers can self aggregate in some cases, or can be, at least in part, aggregated mechanically.

In some embodiments the host resin network is impregnated into a mica paper. In such cases the second class of fillers aggregate with greater concentration within voids in the mica paper. In other embodiments the high thermal conductivity fillers have been surface treated to introduce surface functional groups that allow for the essentially complete co-reactivity with the host resin network. In certain embodiments the continuous organic-inorganic resin comprises a maximum of 60% by weight of the high thermal conductivity fillers.

In one example the first class of filler is boron nitride and the second class of filler is alumina. Particularly good examples include the boron nitride comprising 15-35% by weight, and the alumina 1-10% by weight, of the total organic-inorganic resin composition.

Although the present invention has been discussed primarily in use with electrical industries, the invention is equally applicable in other areas. Industries that need to increase heat transference would equally benefit from the present invention. For example, the energy, chemical, process and manufacturing industries, inclusive of oil and gas, and the automotive and aerospace industries. Other focuses of the present invention include power electronics, conventional electronics, and integrated circuits where the increasing requirement for enhanced density of components leads to the need to remove heat efficiently in local and large areas. Also, while specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. A high thermal conductivity resin comprising:
a host resin matrix; and
a high thermal conductivity filler;
wherein said high thermal conductivity filler forms a continuous organic-inorganic composite with said host resin matrix;
wherein said high thermal conductivity fillers are from 1-1000 nm in length, and wherein said high thermal conductivity fillers have an average aspect ratio of between 3-100;
wherein at least a portion of said high thermal conductivity fillers comprise morphologies chosen from the group consisting of hexagonal, cubic, orthorhombic, rhombohedral, tetragonal, whiskers and tubes.

2. The high thermal conductivity resin of claim 1, wherein a portion of said high thermal conductivity fillers aggregate into secondary structures, whereby said aggregates are held together by chemical or physical bonding.

3. The high thermal conductivity resin of claim 2, wherein interconnection between secondary structures create thermal conduction through said host resin matrix.

4. The high thermal conductivity resin of claim 2, wherein said aggregate secondary structures form at least one of stacks, spheroids, splayed spheres, sheets, dendritic starts and pearl necklaces.

5. The high thermal conductivity resin of claim 2, wherein up to 50-100% by weight of said high thermal conductivity fillers form secondary structures.

6. The high thermal conductivity resin of claim 2, wherein 5-50% of said high thermal conductivity fillers do not form secondary structures.

7. The high thermal conductivity resin of claim 2, wherein the high thermal conductivity fillers that do not form secondary structures are of a different type of filler than high thermal conductivity fillers that form secondary structures.

8. The high thermal conductivity resin of claim 1, wherein said high thermal conductivity fillers comprise fillers that are decorated with nano fillers.

9. The high thermal conductivity resin of claim 8, wherein the nano fillers comprise 5-10% by weight of the total nano-decorated filler.

10. The high thermal conductivity resin of claim 8, wherein multiple secondary structures are formed within the same host resin matrix.

11. The high thermal conductivity resin of claim 1, wherein said high thermal conductivity fillers comprises hexagonal BN.

12. The high thermal conductivity resin of claim 11, wherein said hexagonal BN is approximately 50-200 nm in length.

13. The high thermal conductivity resin of claim 11, wherein said hexagonal boron nitride fillers aggregate into stacks.

14. The high thermal conductivity resin of claim 11, wherein smaller hexagonal BN fillers decorate larger hexagonal BN fillers.

15. The high thermal conductivity resin of claim 11, wherein the high thermal conductivity filler further comprise rod shaped fillers.

16. The high thermal conductivity resin of claim 1, wherein said high thermal conductivity fillers have an average aspect ratio of between 10-50.

17. The high thermal conductivity resin of claim 1, wherein reactive surface groups are present on said thermal conductivity filler.

18. A continuous organic-inorganic resin comprising:
a host resin network;
a first class of inorganic high thermal conductivity fillers evenly dispersed in said host resin network and essentially completely co-reacted with said host resin network; and
a second class of inorganic high thermal conductivity fillers unevenly dispersed in said host resin network, wherein said second class of inorganic high thermal conductivity fillers aggregate into secondary structures;
wherein said high thermal conductivity fillers have a length of between 1-1000 nm and an average aspect ratio of 3-100;
wherein said high thermal conductivity fillers are selected from at least one of oxides, nitrides, and carbides;
wherein at least a portion of said high thermal conductivity fillers comprise morphologies chosen from the group consisting of hexagonal, cubic, orthorhombic, rhombohedral, tetragonal, whiskers and tubes.

19. The continuous organic-inorganic resin of claim 18, wherein said second class of fillers self aggregate.

20. The continuous organic-inorganic resin of claim 18, wherein said second class of fillers are at least in part aggregated by an external mechanism.

21. The continuous organic-inorganic resin of claim 18, wherein said host resin network is impregnated into a mica paper.

22. The continuous organic-inorganic resin of claim 21, wherein said second class of fillers aggregate with greater concentration within voids in said mica paper.

23. The continuous organic-inorganic resin of claim 18, wherein said high thermal conductivity fillers have been surface treated to introduce surface functional groups that allows for the essentially complete co-reactivity with said host resin network.

24. The continuous organic-inorganic resin of claim 18, wherein said continuous organic-inorganic resin comprises a maximum of 60% by volume of said high thermal conductivity fillers.

25. The continuous organic-inorganic resin of claim 18, wherein said first class of filler is boron nitride and wherein said second class of filler is alumina

26. The continuous organic-inorganic resin of claim 25, wherein the boron nitride comprises 15-30% by weight of said continuous organic-inorganic resin, and wherein said alumina comprises 1-10% by weight of said continuous organic-inorganic resin.

27. The continuous organic-inorganic resin of claim 18, wherein the ratio of said second class of fillers to said first class of fillers is between 3:1 to 10:1 by weight.
